(19) United States
(12) Patent Application Publication
(10) Pub. No.: US 2007/0113195 A1
(43) Pub. Date: May 17, 2007

(54) Automatic and persistent X window control for multiple applications and multiple windows per application

(76) Inventors: Daniel Tormey, Richardson, TX (US); Joe Bolding, Richardson, TX (US); Ronald Gilbert JR., Richardson, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/281,830

(22) Filed: Nov. 17, 2005

(51) Int. Cl. G06F 3/00

(52) U.S. Cl. 715/781

(57) ABSTRACT

System and method for controlling presentation of windows on a computer display are described. In one embodiment, the system comprises a text file associated with an application, the text file comprising at least one data string, wherein each data string is associated with a window and comprises window configuration information for the window with which it is associated; and window configuration software for accessing the text file responsive to opening of the application, for obtaining from the text file window configuration information for a window, and for causing the window to be presented on the display in accordance with the window configuration information.

### BACKGROUND

In computing, the X Window System (“X”) is a windowing system for bitmap displays. It is a standard toolkit and protocol for building graphical user interfaces (GUIs) on Unix, Unix-like operating systems, and OpenVMS and is available for most modern operating systems.

X provides a basic framework for a GUI environment, including drawing and moving windows on the screen and interacting with a mouse and a keyboard. X does not mandate the user interface; that aspect is handled by individual applications programs. As such, the visual styling of X-based environments varies greatly; different applications may present radically different interfaces.

Currently, in X, a user may either manually position, size, and set other attributes for each X window every time an application (or group of applications) is run or employ one of a variety of methods on a per window basis manually to configure the windows before an application is started.

In other windowing environments, such as Microsoft® Windows, it is a feature of some applications that when a user starts the application, the application window is opened in the same place it was and with the same size and other characteristics it possessed when the application was previously closed. Unfortunately, not all applications possess this feature. Additionally, even for applications that do possess this feature, it would not be uncommon for several instances of such an application to be executing, with application windows for each instance displayed in a different location and with a different size and other characteristics. In this situation, when restarted after being shut down, the application window of the last instance to be closed will dictate the location, size, and other characteristics of the newly opened application window. This will occur even in cases in which the user intended another of the previously opened application windows to be controlling. Moreover, in cases in which multiple instances of an application are running, there is no way to specify different relative positions and sizes for the corresponding windows upon opening; rather, the window for each instance of the application will be opened in the same location and with the same size, at which point it may be reconfigured by the user.

As previously indicated, in X, a user can specify a location and size for the window of a particular application; however, this specification will be applied for all instances of the application. Currently, there is no way for a user to specify a different location and configuration for the respective window of each of the multiple instances of a single application. Additionally, the windows have no ability to “learn” either their preferred location or other attributes such that they are preconfigured and open in a designated location each time the application is opened.

### BRIEF DESCRIPTION OF THE DRAWINGS

FIGS. 1A-1C depict exemplary representations of a variety of manners in which a plurality of windows associated with an application or a group of applications may be presented on a display;

FIG. 2 depicts a block diagram of a computer system in which an exemplary embodiment for automatic and persistent window control for multiple applications and multiple windows per application is implemented; and

FIG. 3 depicts a flowchart of the operation of an embodiment for automatic and persistent window control for multiple applications and multiple windows per application.

### DETAILED DESCRIPTION OF THE DRAWINGS

In the drawings, like or similar elements are designated with identical reference numerals throughout the several views thereof, and the various elements depicted are not necessarily drawn to scale.

As will be described in greater detail hereinbelow, in one embodiment, a text file is maintained that includes placement, size, and other attribute information (collectively “window configuration information”) associated with each of a group of windows on a per-window basis. In operation, before creating a window, a window configuration software module examines the text file containing the configuration information for the window being created (which is identified by name) and retrieves the window configuration information for the window. As previously noted, the window configuration information includes, at a minimum, the size and location of the window on the display. The window configuration information may additionally include such attributes as background and foreground color, whether the window is to be iconized, whether the text file is to be updated automatically (e.g., each time the window is moved) or manually (e.g., responsive to the user's entering a command to save the window configuration information corresponding to the current presentation of the window on the display).

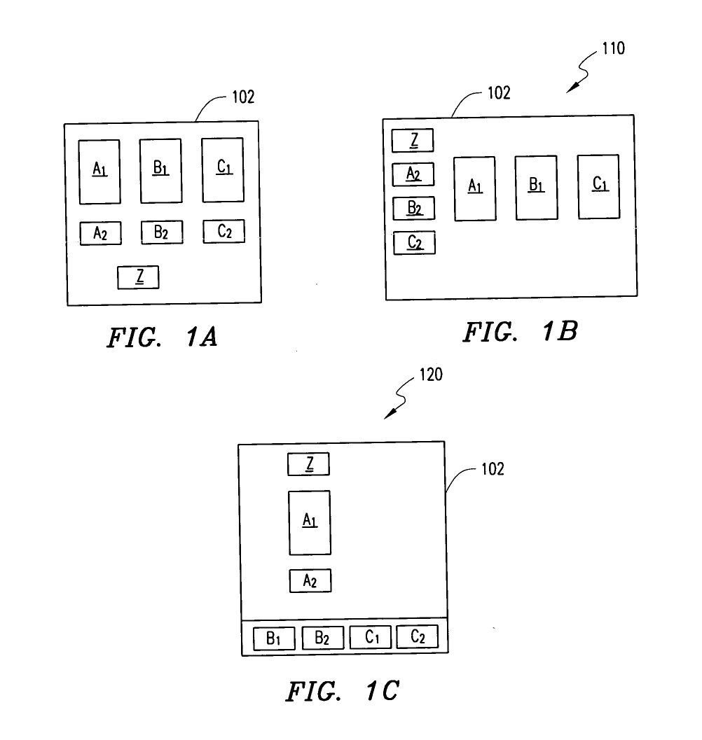

Referring now to FIGS. 1A-1C, depicted therein are exemplary representations of a variety of manners in which a plurality of windows, designated A1, A2, B1, B2, C1, C2, and Z, associated with an application or a group of applications, may be presented on a display. In particular, FIG. 1A illustrates a first configuration 100 in which the windows A1, B1, and C1, are similar to one another in size and shape and are displayed next to one another on the upper half of a display 102. Similarly, windows A2, B2, and C2 are similar to one another in size and shape and are presented immediately beneath windows A1, B1, and C1, respectively. A control window Z is used to interact with an embodiment of a windows configuration system of one embodiment.

In contrast, referring to FIG. 1B, the same seven windows A1, A2, B1, B2, C1, C2, and Z, are presented in a alternative configuration, designated by a reference numeral 110. In the configuration 110, once again, the windows A1, B1, and C1 are similar to one another in size and shape, but in contrast to the configuration 100 (FIG. 1A), in the configuration 110, the windows A1, B1, and C1, are presented on the rightmost ¾ of the display 102. Windows A2, B2, and C2 are again similar to one another in size and shape, but are presented on the leftmost ¼ of the display 102 and are positioned one atop the other. The control window Z is displayed in the top left corner of the display 102.

FIG. 1C illustrates yet another alternative configuration 120 of the windows A1, A2, B1, B2, C1, C2, and Z. In the configuration 120, the windows A1, A2, and Z are displayed full scale on a main portion of the display 102, but the remaining windows B1, B2, C1, and C2, are iconized and displayed near the bottom of the display 102.

It will be recognized that the three configurations 100, 110, and 120, illustrated in FIGS. 1A-1C, are illustrative only and that there are any number of different manners in which any number of windows may be configured on a display. It should also be noted that the illustrated configurations 100, 110, 120, may belong to three different users or may belong to a single user, who may select which configuration to use for a particular purpose. Additionally, in accordance with features of one embodiment, the configurations 100, 110, 120, may be shared among multiple users.

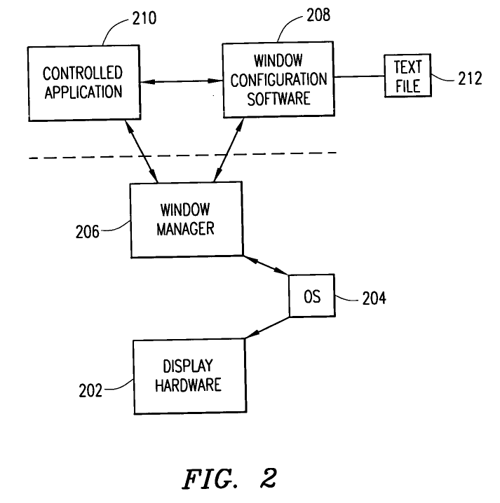

FIG. 2 is a block diagram of a computer system 200 in which an exemplary embodiment is implemented. As shown in FIG. 2, the system 200 includes display hardware 202 for displaying, under the control of the operating system (“OS”) 204, a user interface, which may include, for example, GUI elements such as windows. A windows manager 206 is provided for interacting with the OS 204 for creating windows, such as those illustrated in FIGS. 1A-1C, to be presented via the display hardware 202. It will be recognized that, in some implementations, the windows manager 206 may reside within the OS 204, rather than existing as a separate element.

In one embodiment, window configuration software 208 interacts with the windows manager 206 such that when an application 210 the display of which is controlled by the window configuration software is opened, the window configuration software 208 accesses a text file 212 associated with the application 210 and accesses the window configuration information for each window (which is identified by name in the text file 212) to be displayed via the display hardware 202. In one embodiment, the window configuration information for each window comprises a data string associated with the window. This windows configuration information is provided to the window manager 206, which causes the OS 204 to display the windows accordingly.

In one embodiment, each controlled application, such as the application 210, has associated therewith a text file, such as the text file 212. The text file comprises one or more data strings, each of which is associated by name with a window to be displayed in connection with the controlled application. Each data string comprises window configuration information for the window with which it is associated. As previously noted, such window configuration information may include, but is not limited to, window size, location on the display (e.g., x, y coordinates), position of the window relative to other windows (e.g., in cases where the window is cascaded with other windows), background color, foreground color, etc.

For example, referring to FIG. 1A, a text file for the illustrated configuration 100 would have a data string associated with the window A1 comprising the window configuration information for the window A1, a data string associated with the window A2 comprising the window configuration information for the window A2, a data string associated with the window B1 comprising the window configuration information for the window B1, a data string associated with the window B2 comprising the window configuration information for the window B2, and so on. A separate text file would be provided for each of the configurations 110 and 120; each of those text files will also include a data string for each of the windows displayed thereon.

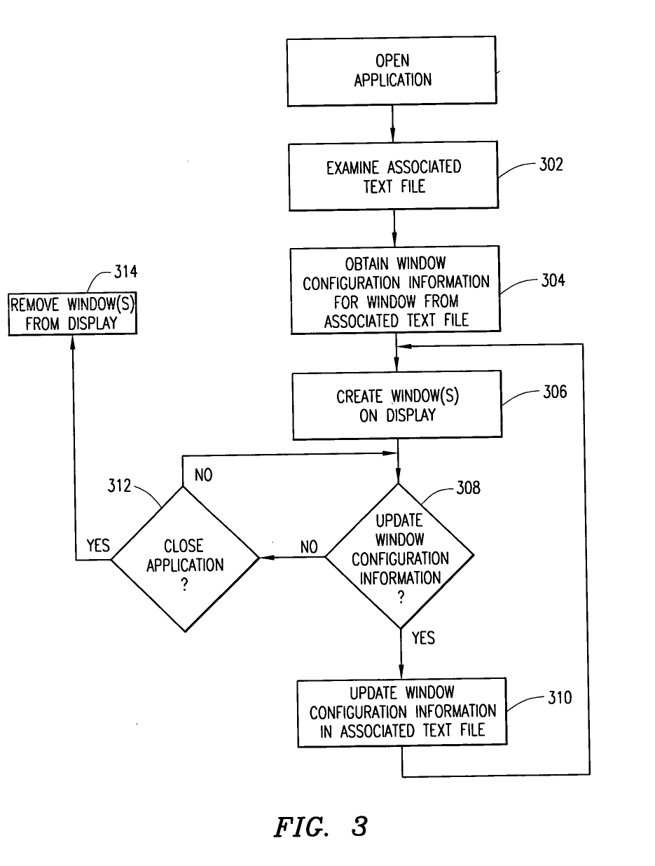

FIG. 3 is a flowchart of the operation of an embodiment for automatic and persistent window control for multiple applications and multiple windows per application. Responsive to an application (or related group of applications) being opened (block 300), a text file associated with the application or group of applications and containing window configuration information for the windows to be displayed is accessed and examined by window configuration software (block 302). The window configuration software provides to the windows manager configuration information for each of the one or more windows listed in the text file and identified by name (block 304). The windows manager displays each of the windows using the configuration information provided (block 306).

As previously indicated, the text file for a particular controlled application may be updated in several ways. For example, in one implementation, the text file is only updated in response to a command from the user (e.g., via a command line interface or selection of a menu option, for example). In another implementation, the text file is updated each time a window of the controlled application is moved. In yet another implementation, two files may be maintained for a controlled application, in which case one of the text files is updated in response to user commands whereas the other is updated each time a window of the controlled application is moved. In this implementation, one of the text files may be selected as the default configuration or the user may be prompted to specify which text file to use in configuring the application windows.

After the window or windows have been displayed, if the window parameters for any of the displayed windows are to be changed, which may be indicated by the user in any of the manners described above, depending on the particular implementation (block 308), the window configuration for the window is updated in the text file (block 310) and the window or windows are redisplayed (block 306). If the application or group of applications is closed (block 312), the associated windows are removed from the display (block 314).

Based on the foregoing Detailed Description, it should be appreciated that an implementation of the embodiments described herein thus provides system and method for implementing automatic and persistent window control for multiple applications and multiple windows per applications. The embodiments enable application window configurations to be transferred, via the associated text file, to multiple users such that all of them can use the same configuration. Additionally, because the text files can be edited using a text editor, the configuration of an application's windows can be “tweaked” manually to ensure, for example, that windows are an exact size and displayed in an exact location with respect to other windows. Finally, the embodiments enable a user to maintain configuration information for multiple windows per application.

Although the invention has been described with reference to certain exemplary embodiments, it is to be understood that the forms of the invention shown and described are to be treated as illustrative only. Accordingly, various changes, substitutions and modifications can be realized without departing from the scope of the present invention as set forth in the following claims.

What is claimed is:

1. A system for controlling presentation of windows on a computer display, the system comprising:
a text file associated with an application, the text file comprising at least one data string, wherein each data string is associated with a window and comprises window configuration information for the window with which it is associated; and
window configuration software for accessing the text file responsive to opening of the application, for obtaining from the text file window configuration information for a window, and for causing the window to be presented on the display in accordance with the window configuration information.

2. The system of claim 1 wherein the window configuration information comprises at least one of a location of the window on the display, a size of the window, a background color for the window, a foreground color for the window, and an indication of whether the window is to be iconized.

3. The system of claim 2 wherein the window configuration information comprises an indication of whether the window configuration information is to be updated manually or automatically.

4. The system of claim 3 wherein, responsive to the window configuration information indicating that the window configuration information is to be updated automatically, the window configuration software updates the window configuration information each time a configuration of the window is changed on the display.

5. The system of claim 4 wherein, responsive to the window configuration information indicating that the window configuration information is to be updated manually, the window configuration software updates the window configuration information responsive to one or more commands from the user.

6. The system of claim 1 wherein the text file comprises a default text file associated with the application.

7. The system of claim 1 further wherein text file comprises one of a plurality of text files associated with the application wherein, responsive to opening of the application, the window selection software prompts the user to select one of the plurality of text files and, responsive to user selection of one of the plurality of text files, window configuration software accesses the selected text file.

8. A method for controlling presentation of windows on a computer display, the method comprising:
responsive to an application being opened, accessing a text file associated with the application;
obtaining from the text file window configuration information for a window; and
presenting the window on the display in accordance with the window configuration information,
wherein the window configuration information comprises an indication of whether the window configuration information is to be updated manually or automatically.

9. The method of claim 8 wherein the window configuration information comprises at least one of a location of the window on the display, a size of the window, a background color for the window, a foreground color for the window, and an indication of whether the window is to be iconized.

10. The method of claim 8 further comprising, responsive to the window configuration information indicating that the window configuration information is to be updated automatically, updating the window configuration information each time a configuration of the window is changed on the display.

11. The method of claim 8 further comprising, responsive to the window configuration information indicating that the window configuration information is to be updated manually, updating the window configuration information responsive to one or more commands from the user.

12. The method of claim 8 further comprising updating the window configuration information manually by editing window configuration information in the text file using a text editor.

13. The method of claim 8 wherein the accessing a text file associated with the application further comprises accessing a default text file associated with the application.

14. The method of claim 8 further wherein the accessing a text file associated with the application further comprises:
prompting a user to select one of a plurality of text files associated with the application; and
accessing the selected text file.

15. The method of claim 14 wherein at least one of the plurality of text files associated with the application comprises window configuration information that is updated automatically.

16. The method of claim 14 wherein at least one of the plurality of text files associated with the application comprises window configuration information that is updated manually.

17. A system for controlling presentation of windows on a computer display, the system comprising:
means responsive to an application being opened for accessing a text file associated with the application;
means for obtaining from the text file window configuration information for a window; and
means for presenting the window on the display in accordance with the window configuration information,
wherein the window configuration information comprises an indication of whether the window configuration information is to be updated manually or automatically.

18. The system of claim 17 wherein the window configuration information comprises at least one of a location of the window on the display, a size of the window, a background color for the window, a foreground color for the window, and an indication of whether the window is to be iconized.

19. The system of claim 17 further comprising means responsive to the window configuration information indicating that the window configuration information is to be updated automatically for updating the window configuration information each time a configuration of the window is changed on the display.

20. The system of claim 17 further comprising means responsive to the window configuration information indicating that the window configuration information is to be updated manually for updating the window configuration information responsive to one or more commands from the user.

21. The system of claim 17 wherein the means for accessing a text file associated with the application further comprises means for accessing a default text file associated with the application.

22. The system of claim 17 further wherein the means for accessing a text file associated with the application further comprises:
means for prompting a user to select one of a plurality of text files associated with the application; and
means for accessing the selected text file.

23. The system of claim 22 wherein at least one of the plurality of text files associated with the application comprises window configuration information that is updated automatically.

24. The system of claim 22 wherein at least one of the plurality of text files associated with the application comprises window configuration information that is updated manually.
